(19) United States
(12) Patent Application Publication
(10) Pub. No.: US 2002/0009352 A1
(43) Pub. Date: Jan. 24, 2002

(54) Book cover with a round-arch spine and a method for producing the same

(76) Inventor: Daijiro Nakabayashi, Osaka (JP)

Correspondence Address: THOMPSON HINE L.L.P., 2000 COURTHOUSE PLAZA , N.E., 10 WEST SECOND STREET, DAYTON, OH, 45402, US

(21) Appl. No.: 09/860,086

(22) Filed: May 17, 2001

(30) Foreign Application Priority Data
May 18, 2000 (JP) 2000-146408

(51) Int. Cl. B42C 1/00; B42B 2/00; B42C 11/00

(52) U.S. Cl. 412/1

(57) ABSTRACT

The present invention provide a book cover with a stable round-arch spine with a simple structure without regard to materials and shape of an object to be bound, and provide a method for producing the said book cover.

The said book cover with a round-arch spine comprising a mounting cloth folding corners thereof on which a pair of substratum paper and a spine affiche of synthetic resin are placed, a backing paper adhered on a back surface of the book cover, and the spine affiche heat-formed into a round shape. A method for producing the said book cover has a process of placing a pair of substratum paper and a spine affiche to a suitable position of the mounting cloth, a process of folding inside a top and bottom and ends of right and left of the mounting cloth, and a process of adhering the backing paper to a back surface of the book cover, and a process of heat-forming the spine affiche to a round shape.

### FIELD OF THE INVENTION

The present invention relates to a book cover for an album, a sketchbook and the like having a stable round-arch spine unaffected by a shape of an object to be bound, and a method for producing the said book cover.

### DESCRIPTION OF THE PRIOR ART

As binding styles, there have been a round-arch spine and a squarish spine style. In a round-arch spine binding, an object for binding is first bulged and then sheathed by a book cover along rounds formed. Accordingly, not that an object is formed in accordance with a shape of a round-arch spine, but that a spine has to be shaped into a round to suit a backstrip of the object to be bound. With a method described above, difficulties stand in binding sheets having intervals therebetween and hinged yielding papers such as a mount for an album. Therefore, binding untouched sheets or hinged yielding papers has been impossible. In the case of a file and a holder comprised of a book cover and a content (for example, a pocket mount) both made from synthetic resin, a round-arch spine binding has been already adopted as disclosed in Japanese Patent No. 2,682,949 and Japanese Open Gazette No. H3-254999. However, since a conventional book cover with a round-arch spine is made from synthetic resin and wherein a mount is adhered to an exposing resin surface of a spine, a mount has to be synthetic resin and cannot be a paper in the view of adhesive characteristics of both the book cover and the mount. In the above binding, as a high frequency welding machine or a heat apparatus is required to bond resins, procedures has been complex and costs has been expensive. The present invention offers a book cover with a stable round-arch spine which has a simple composition and is unaffected by a material or a form of an object to be bound, and a method for producing the same.

### SUMMARY OF THE INVENTION

To resolve the above problem, the invention in claim 1 adopts a book cover with a book cover with a round-arch spine comprising a mounting cloth with folding up corners thereof on which a pair of substratum paper and a spine affiche of synthetic resin are pre-positioned, and a backing paper adhered on a back surface of the mounting cloth wherein a round shape in the said spine affiche is produced by heat-forming.

As a producing method of a book cover with a round-arch spine, the invention in claim 2 adopts a procedure of placing a pair of substratum paper and a spine affiche of synthetic resin on suitable positions on a mounting cloth, a procedure of folding a top, a bottom and ends of right and left of the said mounting cloth inside, a procedure of adhering a paper to a back surface of a book cover, and a procedure of heat-forming the said spine affiche into a round shape. By using a spine affiche of synthetic resin, the said spine affiche can be heat-formed and retain a stable round shape thereof, which facilitate binding books with intervals or binding yielding papers. Also, a back surface of a spine affiche remains feasible to be bound with a conventional binding procedure because of a backing paper thereon. Furthermore, the invention in claim 2, which adds a procedure of heat-forming a spine affiche to conventional procedures for producing a book cover, results in simplifying manufacturing apparatus and manufacturing processes and lightening costs as a process of adhering a synthetic resin mount to a synthetic resin book cover will not be needed.

### BREIF DESCRIPTION OF THE DRAWINGS

FIG. 1 is a top view showing a structure of a book cover.

FIG. 2 is partly sectioned view showing an example of a heat-forming process.

FIG. 3 is a perspective view of a book cover with a round-arch spine completed.

FIG. 4 is a partly sectioned view showing an example of a bound album.

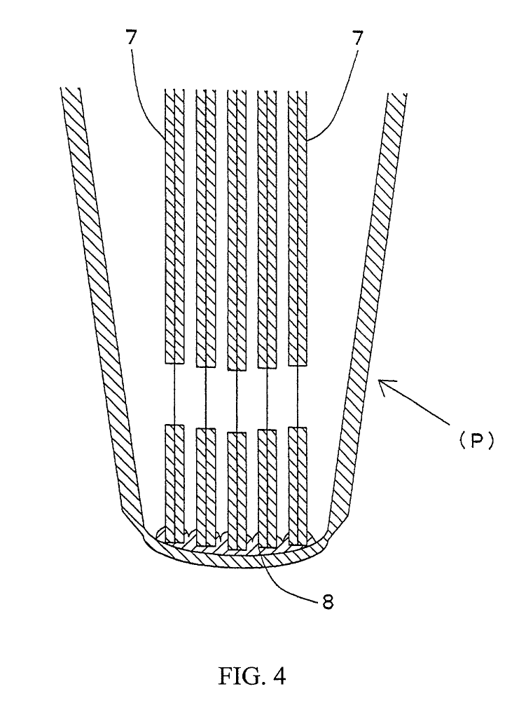

### DETAILED DESCRIPTION OF THE PREFERRED EMBODIMENT

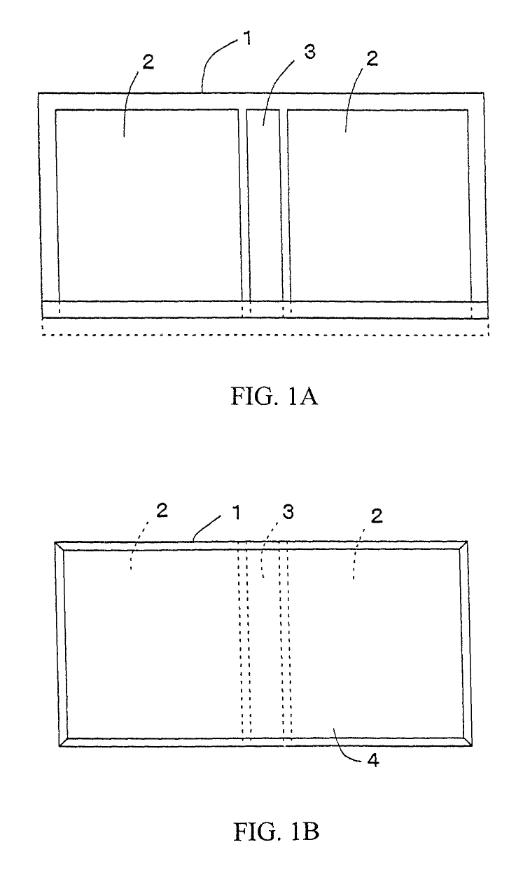

Hereafter, preferred embodiments of a book cover with a round-arch spine in the present invention are explained referring to the drawings. FIG. 1 is a schematic diagram showing a structure of a book cover. In this figure, 1 is a mounting cloth, 2 is a pair of substratum paper and 3 is a spine affiche. Conventional materials are used for the mounting cloth 1 and substratum paper 2. As to the spine affiche 3, a synthetic resin paper such as “peachcoat” (Nisshinbo Industries Inc.) and “yupo” (Oji Paper Co., Ltd.) are used.

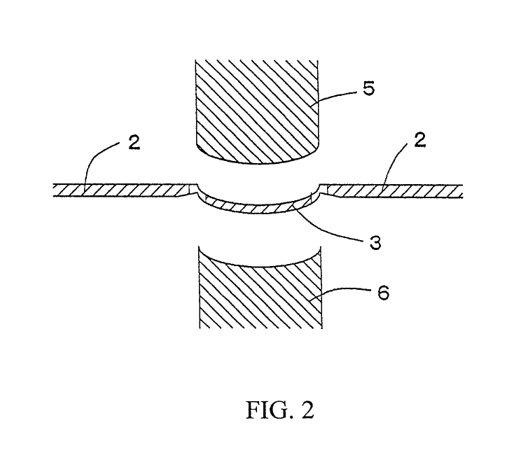

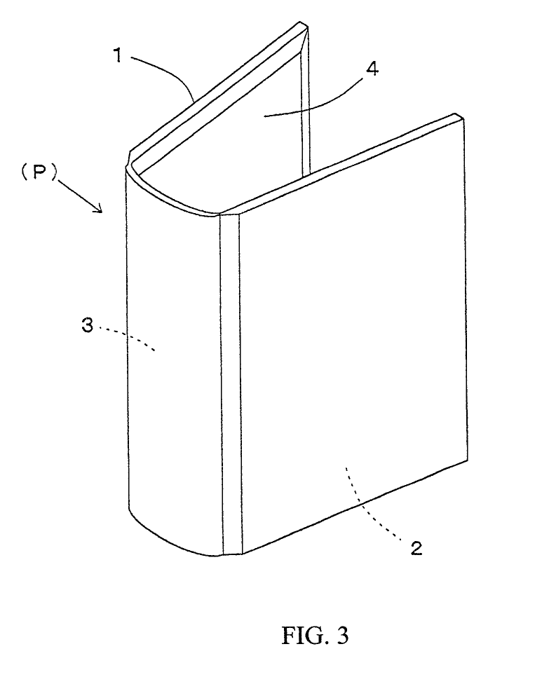

As a book cover manufacturing process, adhesives are applied on a back surface of said mounting cloth 1 and said substratum paper 2 and said spine affiche 3 are placed on predetermined positions. Then a top and a bottom of said mounting cloth are folded and ends of right and left thereof are further folded. FIG. 1(A) shows the mounting cloth with a bottom thereof folded. After folding four corners up and treating thereof suitably, said backing paper 4 is adhered on a whole back surface remaining slight space at four corners (please refer to FIG. 1(B)). A synthetic resin paper used for a spine affiche in each processes has a surface characteristic equivalent to a paper made from organic fiber such as a conventional paper wood pulp and has a print aptitude and adhesiveness to stick and adhesive as well as natural paper, which enables to adapt a conventional book cover-adhering process. A round-arch shape in a spine portion is formed with a pair of heat-molds. As shown in FIG. 2, the said round-arch spine is formed by pressing with an even heat-mold 5 having desired roundness and an uneven heat-mold 6. This process may be conducted by heating from outside. Since a synthetic resin paper used for a spine affiche is composed of radical material of thermoplastic resin, desired roundness is easily formed and maintained stably when the synthetic resin paper is heat-formed at a required temperature. With processes explained above, a book cover with a round-arch spine (P) as shown in FIG. 3 is easily manufactured.

A book cover with a round-arch spine produced with above processes can be bound with conventional binding processes. For example, as disclosed in Japanese Open Gazette Nos. H4-126297 and H6-320883, an album having intervals between mounts can be bound with a process of placing spacers between a plurality of mounts and supporting the said plurality of mounts by a pair of pinch-board, a process of applying heat-soluble adhesive on at a binding side of the said plurality of mounts, a process of bonding the said binding side to an interior surface of a round-arch spine, a process of cooling down the adhesive, and a process of removing the said spacers after the adhesive has consolidated. According to a book cover with a round-arch spine in the present invention, as the said book cover is previously shaped into a round-arch, a luxurious album can be produced with above processes.

As explained above, a book cover with a round-arch spine and a method for producing the same in the present invention can easily produce luxurious bound book with a round-arch spine since a roundness of a spine is stable even in binding sheets having intervals therebetween or in binding hinged yielding papers owing to the said spine affiche of synthetic resin, thermoplastic character of which enable a book cover to have the said roundness in the said spine in advance by heat-forming.

Also, like conventional bound books, as a backing paper is adhered to a back surface of a book cover, a paper is bound with a conventional binding method. Therefore, a luxurious appearance can be obtained without losing an exclusive quality sense.

Furthermore, since the present invention requires to add only one process of heat-forming a spine affiche to a conventional manufacturing processes which means a large facility such as a high frequency welding apparatus is not needed therein, time and cost involved with manufacturing procedures can be considerably lightened.

What is claimed:

1. A book cover with a round-arch spine comprising;
a mounting cloth with folding up corners thereof on which a pair of substratum paper and a spine affiche of synthetic resin are pre-positioned,
and a backing paper adhered on a back surface of the mounting cloth,
wherein a round shape is obtained by heat-forming the said spine affiche.

2. A producing method of the book cover with a round-arch spine developed with;
a procedure of placing a pair of substratum paper and a spine affiche of synthetic resin on suitable positions of a mounting cloth,
a procedure of folding inside a top and a bottom and ends of right and left of the mounting cloth,
a procedure of adhering a backing paper to a back surface of a book cover,
and a procedure of heat-forming the spine affiche to a round shape.
